(19) United States
(12) Patent Application Publication
(10) Pub. No.: US 2026/0119486 A1
(43) Pub. Date: Apr. 30, 2026

(54) MULTI-AGENT FRAMEWORK FOR OPTIMIZED QUERY EXECUTION IN FEDERATED DATA SYSTEMS

(71) Applicant: BOOMI, LP, Conshohocken, PA (US)

(72) Inventors: Swagata ASHWANI, San Francisco, CA (US); Ayush PARASHAR, Foster City, CA (US); Christopher PEDROTTI, San Jose, CA (US); Thomas BENJAMIN, Foster City, CA (US)

(73) Assignee: BOOMI, LP, Conshohocken, PA (US)

(21) Appl. No.: 19/256,881

(22) Filed: Jul. 1, 2025

(30) Foreign Application Priority Data
Oct. 25, 2024 (IN) 202411081537
Oct. 25, 2024 (IN) 202411081538

(51) Int. Cl. G06F 16/2453; G06F 16/25

(52) U.S. Cl. CPC G06F 16/24535; G06F 16/24532; G06F 16/256

(57) ABSTRACT

A federated data system enables multiple, independent, decentralized, and autonomous data sources to be queried as if they were a single system. State-of-the art federated data systems suffer from excessive data movement, static execution strategies, and inefficient distributed joins. Disclosed embodiments introduce a multi-agent framework into the federation layer of the federated data system. This agentic framework may comprise a supervisor artificial intelligence (AI) agent that divides queries, from a query engine, into subqueries and utilizes other AI agents to perform sub-tasks, such as rewriting one or more the of the subqueries, determining an execution strategy, executing the subqueries according to the execution strategy, and learning from past query executions. The supervisor AI agent may perform in-memory joins of the results of the subqueries, and return a final query result to the query engine.

### CROSS-REFERENCE TO RELATED APPLICATIONS

The present application claims priority to Indian Patent Application No. 202411081537, filed on Oct. 25, 2024, and Indian Patent Application No. 202411081538, filed on Oct. 25, 2024, which are both hereby incorporated herein by reference as if set forth in full.

### BACKGROUND

### Field of the Invention

The embodiments described herein are generally directed to query processing for federated data systems, and, more particularly, to a multi-agent framework for optimized query execution in federated data systems.

### Description of the Related Art

A federated data system is characterized by an architecture that enables multiple, independent, decentralized data sources to be accessed and queried as if they were a single system, without requiring the data to be moved or centralized. The data sources, which may be heterogeneous databases, data lakes, data repositories, or the like, possess autonomy, such that each data source maintains control over its own data. The data sources may even be owned and operated by different entities.

A query engine, which may comprise a user interface and/or application programming interface, enables users or software entities to issue queries using standard languages such as Structured Query Language (SQL), Graph Query Language (GraphQL), and/or the like. A federation layer is positioned between the query engine and the data sources to translate the queries, from the query engine, into subqueries for each data source that is implicated by the query (e.g., using a metadata catalog that maintains information about the data sources, including locations, data schemas, access protocols, etc.), orchestrate execution of the subqueries across the implicated data sources, and merge the results of the subqueries into a single unified result that is returned to the query engine for presentation to the user or software entity that submitted the query.

State-of-the-art federated data systems suffer from a variety of problems. For example, traditional query engines retrieve entire tables, which results in excessive data movement that can lead to high latency, network congestion, and cloud egress costs. In addition, traditional federation layers do not dynamically optimize subqueries based on the intent of the query, which can result in suboptimal query execution. Traditional federation layers also perform joins across data sources that require moving large datasets to a centralized processing node, which results in inefficient distributed joins. Furthermore, current federation layers lack adaptive learning. In other words, they cannot self-optimize based on past patterns of query execution.

### SUMMARY

Accordingly, systems, methods, and non-transitory computer-readable media are disclosed for a multi-agent framework for optimized query execution in federated data systems.

In an embodiment, a method comprises using at least one hardware processor to, in a federation layer of a federated data system that comprises a plurality of distributed data sources: by a supervisor artificial intelligence (AI) agent, receive a query for the federated data system, and decompose the query into a plurality of subqueries; by a query optimization AI agent, rewrite at least one of the plurality of subqueries to minimize data movement; by a data location AI agent, determine an execution strategy that comprises the plurality of subqueries, as rewritten by the query optimization AI agent; by an execution AI agent, execute the plurality of subqueries; by a cursor AI agent, fetch a result of each of the plurality of subqueries, and return the fetched results; and by the supervisor AI agent, perform an in-memory join of the fetched results, to produce a final query result, and return the final query result in response to the received query.

Decomposing the query into a plurality of subqueries may comprise: identifying each of the plurality of distributed data sources referenced in the query; and for each of the identified distributed data sources, generating a subquery.

Decomposing the query into the plurality of subqueries may comprise: generating a prompt that comprises the query and instructs an AI model of the supervisor AI agent to decompose the query into a separate and distinct subquery for each of the plurality of distributed data sources that is referenced in the query; apply the AI model of the supervisor AI agent to the prompt to generate the plurality of subqueries. The AI model may be a large language model that is fine-tuned for generating queries.

Rewriting the at least one subquery may comprise rewriting the at least one subquery to perform filtering at a respective one of the plurality of distributed data sources to which the at least one subquery is directed, prior to data retrieval from the respective distributed data source.

During execution of the plurality of subqueries, when a smaller table must be joined with a larger table, the smaller table may be temporarily copied to a location of the larger table, and the join may be performed at the location of the larger table and the copy of the smaller table.

The cursor AI agent may maintain a cursor to fetch the result of each of the plurality of subqueries and return the fetched results in batches. A size of the batches may be limited to a maximum size, wherein the maximum size is adjusted, over time, based on one or more real-time factors.

Two or more of the plurality of subqueries may be executed in parallel.

The method may further comprise using the at least one hardware processor to, by a learning AI agent, store the execution strategy in association with a representation of the query and metadata about execution of the query. The metadata may comprise one or more performance metrics for the execution of the query. The method may further comprise using the at least one hardware processor to, by the learning AI agent, when the one or more performance metrics satisfy one or more criteria, store the execution strategy in historical data used to optimize future queries. The method may further comprise using the at least one hardware processor to, by the learning AI agent, recommend a modification to a schema of at least one of the plurality of distributed data sources based on the one or more performance metrics, wherein the modification comprises an addition of an index to the schema.

The query may be received from a query engine of the federated data system, wherein the final query result is returned to the query engine. The query may be received by the query engine from a user via a user interface. The query may be received by the query engine from a software entity via an application programming interface of the query engine. The software entity may be an integration process.

The federation layer may be hosted on an integration platform as a service (iPaaS) platform.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example federation layer, according to an embodiment; and

FIG. 4 illustrates an example process for optimized query execution in federated data systems, according to an embodiment.

### DETAILED DESCRIPTION

Embodiments of systems, methods, and non-transitory computer-readable media are disclosed for a multi-agent framework for optimized query execution in federated data systems. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

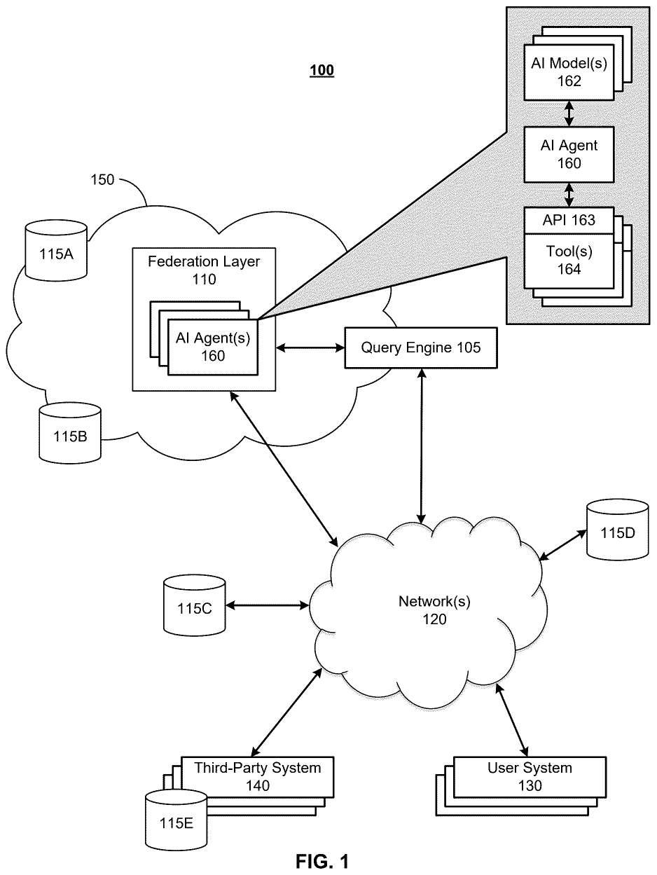

FIG. 1 illustrates an example infrastructure 100, in which one or more of the processes described herein may be implemented, according to an embodiment. Infrastructure 100 may comprise a federated data system that comprises a query engine 105, a federation layer 110, and a plurality of distributed data sources 115.

As used herein, a reference numeral with an appended letter will be used to refer to a specific component, whereas the same reference numeral without any appended letter will be used to refer collectively to a plurality of the component or to refer to a generic or arbitrary instance of the component. Thus, for example, the term “data sources 115” refers collectively to data sources 115A, 115B, 115C, 115D, and 115E, and the term “data source 115” may refer to any single one of data sources 115A, 115B, 115C, 115D, or 115E.

Query engine 105 may receive queries from users and/or software entities. For example, query engine 105 may serve a user interface, such as a graphical user interface, over network(s) 120, to user system 130, and a user at user system 130 may input a query within the user interface to submit the query to query engine 105 over network(s) 120. Similarly, a software entity, executing, for instance, on a third-party system 140, may submit a query to query engine 105, over network(s) 120, via a remote procedure call to an operation of an application programming interface, provided by query engine 105. Query engine 105 may pre-process each received query, and pass the query to federation layer 110. Federation layer 110 may responsively execute the query, and return a result of the query to query engine 105. Query engine 105 may then return the result of the query to the source of the query, for example, to a user via a user interface or to a software entity via the application programming interface of query engine 105, depending on how the query was submitted. One example of a query engine 105 is the Presto Engine (e.g., the version maintained by the Presto Foundation, or the version maintained by the Trino Software Foundation).

Federation layer 110, which will be described in greater detail elsewhere herein, may execute within a computing environment 150. Federation layer 110 may utilize a multi-agent framework, comprising a plurality of AI agents 160, to execute the queries, received from query engine 105. Execution of a query will often involve a plurality of subqueries to a plurality of distributed data sources 115. The agentic framework may utilize a divide-and-conquer approach that divides the query into a plurality of sub-tasks. Each sub-task may be handled by a respective AI agent, within the agentic framework, that is specifically trained for that sub-task.

Collectively, data sources 115 represent a federated dataset, which may comprise any type of structured data, unstructured data, or a combination of structured and unstructured data. A data source 115 may be located at any location that is communicatively accessible to federation layer. For example, some data sources 115, such as data sources 115A and 115B, may be located within the same computing environment 150 as federation layer 110. Alternatively or additionally, some data sources 115, such as data sources 115C and 115D, may be located in a separate and remote computing environment that is separated from computing environment 150 by network(s) 120. In some cases, a data source 115, such as data source 115E, may be hosted on a third-party system 140. Each data source 115 may be managed independently from one or more, including potentially all, of the other data sources 115, for example, by different operators. Thus, supported query languages, data schemas, access protocols, management methods, and/or the like, may differ across different data sources 115.

A data source 115 may be any source of data or metadata for the federated dataset. Examples of data sources 115 include, without limitation, databases, data lakes, data repositories, software applications (e.g., enterprise resource planning (ERP) software, customer relationship management (CRM) software, accounting software, etc.), and/or the like. It should be understood that data sources 115 may be, and often will be, heterogenous, such that different data sources 115 store different types of data, potentially, according to different schemas.

As illustrated, query engine 105, federation layer 110, one or more data sources 115, one or more user systems 130, and/or one or more third-party systems 140 may be communicatively connected to one or more networks 120. Network(s) 120 enable communication between any pairs of these components of infrastructure 100. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While the components of infrastructure 100 are illustrated as being connected to each other through a single set of network(s) 120, it should be understood that various pairs of these components may be connected to each other via different sets of one or more networks 120. For example, query engine 105 may be connected to a subset of user systems 130 and/or third-party systems 140 via the Internet, but may be connected to another subset of user systems 130 and/or third-party systems 140 via an intranet.

While only a few user systems 130 are illustrated, it should be understood that infrastructure 100 may comprise any number of user system(s) 130. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of an employee of an organization that utilizes the federated dataset and who has a user account for accessing query engine 105. Each user account may be associated with an overarching organizational account for the user's respective organization.

The user of a user system 130 may authenticate with query engine 105, or an overarching software entity that comprises query engine 105, using standard authentication means, to access the federated dataset in accordance with role(s) and/or permission(s) of the associated user account. The user may then interact with query engine 105 to query the federated dataset. It should be understood that multiple users, on multiple user systems 130, may query the federated dataset in this manner, according to the role(s) and/or permission(s) of their associated user accounts.

While only a few third-party systems 140 are illustrated, it should be understood that infrastructure 100 may comprise any number of third-party system(s) 140. Third-party system(s) 140 may comprise any type or types of computing devices capable of wired and/or wireless communication, but will generally comprise server-based platforms. A third-party system 140 may host and/or execute a software application or other software entity that submits queries to and receives query results from query engine 105, pushes data to an AI agent 160 or other software entity in computing environment 150 and/or pulls data from an AI agent 160 or other software entity in computing environment 150 (e.g., via an application programming interface of the AI agent 160 or other software entity), responds to requests or queries from an AI agent 160 or other software entity in computing environment 150, manages a data source 115, and/or the like. Thus, third-party system 140 may be a client or consumer of one or more AI agents 160 and/or the federated dataset, a data source for one or more AI agents 160 and/or the federated dataset, and/or the like. A software entity on a third-party system 140 that utilizes query engine 105 may authenticate with query engine 105, or an overarching software entity that comprises query engine 105, using standard authentication means, to access the federated dataset in accordance with role(s) and/or permission(s) of the associated software entity.

Computing environment 150 will generally be implemented by a server-based platform. The platform may comprise dedicated servers, or may instead be implemented in a computing cloud, such that computing environment 150 is a cloud environment in which the resources of one or more servers are dynamically and elastically allocated to multiple tenants based on demand. In either case, the servers may be collocated and/or geographically distributed. Computing environment 150 may host federation layer 110. In addition, computing environment 150 may host query engine 105 and/or one or more data sources 115 (e.g., data sources 115A and 115B).

Computing environment 150 may be deployed in various configurations to meet different organizational requirements. In the event that computing environment 150 is a cloud environment (e.g., Amazon Web Services™ from Amazon.com, Inc. of Seattle, Washington, Azure™ from Microsoft Corp. of Redmond, Washington, Google Cloud Platform™ from Google LLC of Mountain View, California, etc.), the disclosed system, comprising query engine 105, federation layer 110, and/or one or more data sources 115, can run as a service within the cloud environment. This enables the system to take advantage of elastic computing resources to scale with query complexity and load. For organizations with data sovereignty requirements, the entire system can be deployed within private data centers as an on-premise deployment, with AI agents 160 distributed across computing nodes. A hybrid cloud deployment allows the system to span both cloud and on-premise environments, with AI agents 160 strategically positioned to minimize data movement across security boundaries. In any of these deployment scenarios, communications between components may occur through a secure, fault-tolerant messaging system, with guaranteed delivery and idempotent operations to ensure system reliability.

It should be understood that computing environment 150 may comprise additional software entities to those specifically illustrated. In an embodiment, computing environment 150 may be an integration platform as a service (iPaaS) platform. In this case, computing environment 150 may comprise one or a plurality of integration platforms, each comprising one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support AI agents 160, for example, as tools 164 that are utilized by AI agents 160.

Each integration process, when deployed, may be communicatively coupled to network(s) 120. For example, each integration process may comprise an application programming interface that enables clients to access an integration process via network(s) 120. A client may push data to an integration process through application programming interface, and/or pull data from an integration process through the application programming interface. In an embodiment, an integration process may send queries to query engine 105 to retrieve and/or modify data within the federated dataset. For example, an integration process may submit queries to query engine 105 by performing a remote procedure call of an operation within an application programming interface of query engine 105, and receive query results from query engine 105 in response to the remote procedure call.

As will be discussed in greater detail elsewhere herein, federation layer 110 may comprise an agentic framework that includes a plurality of AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human (i.e., user), other software entity (e.g., query engine 105, other AI agent 160, integration process, third-party application, etc.), or other system. AI agent 160 may collect data, analyze data, communicate with human users and/or other software entities, collaborate with other AI agents 160 to complete a complex task, execute actions, learn and improve over time, and/or the like.

Each AI agent 160 comprises or is communicatively coupled to at least one AI model 162. AI model 162 may be internal to AI agent 160, external but local to AI agent 160 (i.e., within computing environment 150), or external and remote from AI agent 160 (i.e., outside computing environment 150, e.g., hosted on third-party system 140, etc.). An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude Opus, Claude Sonnet, etc.) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLaMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLaMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140, or otherwise separated from computing environment 150 by network(s) 120). AI agent 160 may communicate with a tool 164 via an application programming interface 163 of that tool 164. Application programming interface 163 may provide one or more operations that can be performed by AI agent 160 using the respective tool 164. Each operation may accept zero, one, or a plurality of parameters as input and/or return an output that comprises data representing a response, an acknowledgement, and/or the like. An operation, which may also be referred to as an “endpoint,” may be defined by a base Uniform Resource Locator (URL), a path that indicates the resource or action being requested, an HTTP method defining the action to be performed (e.g., GET, POST, PUT, DELETE, etc.), zero, one, or more request parameters, a response format, an authentication or security protocol, a version number, rate limits, error handling, and/or the like.

Tools 164 enable an AI agent 160 to interact with external systems, and even potentially, the physical world. Each tool 164 may perform a sub-task in support of the overall task of AI agent 160. A task may comprise retrieving data from a source (e.g., a data source 115, another software entity, a local database hosted within computing environment 150, a remote database hosted externally to computing environment 150, a third-party system, application, or database, an integration process, a knowledge base, etc.), transforming, formatting, mapping, cleaning, or otherwise manipulating data, analyzing data, storing data, sending data (e.g., tabular or other structured data, unstructured data, commands, requests, queries, etc.) to a destination (e.g., a data source 115, another software entity, a local database, a remote database, a third-party system, application, or database, an integration process, knowledge base, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

In some cases, an AI agent 160 may be an AI chat agent. In this case, AI agent 160 may implement a chat interface. The chat interface may be comprised or embedded (e.g., as an overlaid chat frame) within another user interface, or may be its own separate and distinct user interface. The chat interface may comprise a graphical user interface, an audio interface, or a combination of graphical and audio user interface (i.e., an audiovisual interface).

### 2. Example Processing System

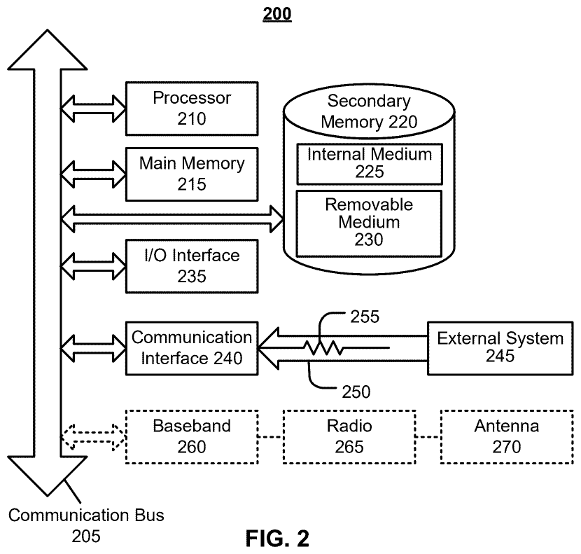

FIG. 2 illustrates an example processing system 200, by which one or more of the processes described herein may be executed, according to an embodiment. For example, system 200 may be used to store and/or execute data sources 115, computing environment 150, AI agent 160, AI model(s) 162, tool(s) 164, and/or may represent components of user system(s) 130, third-party system(s) 140, computing environment 150, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Agentic Framework

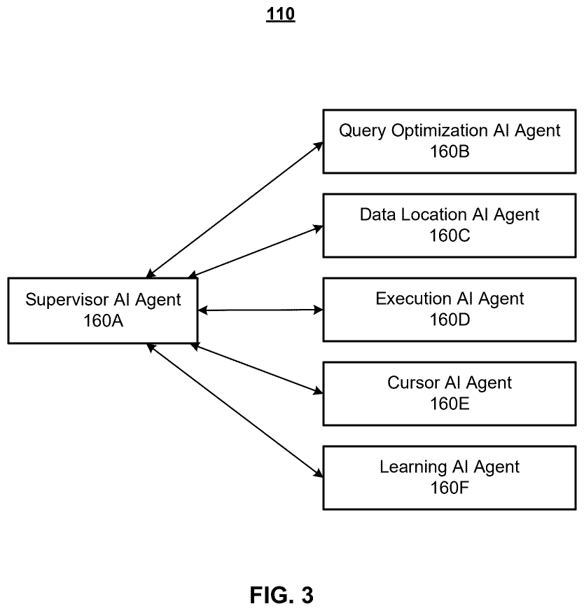

FIG. 3 illustrates an example federation layer 110, according to an embodiment. In particular, federation layer 110 may utilize an agentic framework that comprises a combination of AI agents 160 that work in concert to dynamically optimize query execution, in real time, in a federated data system. As used herein, the terms “real time” and “real-time” refer to events that occur simultaneously with each other, as well as events that are temporally separated from each other by ordinary delays caused, for example, by latencies in processing, communications, memory access, and/or the like, including events that are sometimes referred to as near-real-time events.

In an embodiment, federation layer 110 comprises a plurality of AI agents 160 that include a supervisor AI agent 160A, query optimization AI agent 160B, data location AI agent 160C, execution AI agent 160D, cursor AI agent 160E, and/or learning AI agent 160F. In an alternative embodiment, one or more of these AI agents 160 may be combined or omitted from the agentic framework of federation layer 110, and/or other AI agents 160, not specifically described herein, may be added to the agentic framework of federation layer 110. In any case, each AI agent 160 may specialize in a different aspect of query execution, under the overall supervision of supervisor AI agent 160A.

Preferably, federation layer 110 includes at least cursor-based data retrieval, self-learning query optimization, and/or intent-aware optimization. In cursor-based data retrieval, federation layer 110 retrieves only the data that are necessary for the query, which minimizes expensive cross-system data movement. In self-learning query optimization, historical data for past query executions is used to continuously refine future query execution. In intent-aware optimization, the intent of a query is analyzed to rewrite the query, in order to push data filtering to data sources 115 prior to data retrieval from those data sources 115.

AI model 162 of one or more AI agents 160, within the agentic framework of federation layer 110, may be a generative AI model, such as a generative language model. The generative language model may be a large language model or small language model, including potentially any of the generative language models mentioned herein or other generative language models not specifically mentioned herein. In furtherance of its respective task, AI agent 160 may generate an input to AI model 162 based on any of the data utilized by AI agent 160. In particular, AI agent 160 may incorporate relevant data into a predefined template to generate a prompt, which may comprise or consist of a natural-language expression. The predefined template may comprise a pre-conversation and/or post-conversation, which provide context and/or instructions for AI model 162, and one or more placeholders into which the relevant data are inserted. The pre-conversation and/or post-conversation may define the role of AI model 162 model (e.g., to respond to a query, request, or other input according to the relevant data and a current context, summarize the relevant data, generate image or video data or software code from the relevant data, perform an action, etc.), define an output format for AI model 162 (e.g., natural language, a table, a list structure, a hierarchical structure, a markup-language structure, etc.), and/or the like. The prompt is input to AI model 162 to produce a response from AI model 162 (e.g., in the output format defined by the prompt). It should be understood that an AI model 162 for a respective AI agent 160 may be fine-tuned or otherwise specifically trained for the particular task of AI agent 160.

Supervisor AI agent 160A may divide a query, received from query engine 105, into a plurality of subqueries, assign tasks within the overall query execution to each of the other AI agents 160 (e.g., query optimization AI agent 160B, data location AI agent 160C, execution AI agent 160D, cursor AI agent 160E, and/or learning AI agent 160F), and aggregate the results of the plurality of subqueries into a final query result. Supervisor AI agent 160A may assign the task of rewriting the query to query optimization AI agent 160B, assign the task of determining the execution strategy to data location AI agent 160C, assign the task of executing the subqueries to execution AI agent 160D, assign the task of maintaining a cursor to cursor AI agent 160E, and/or assign the task of learning to learning AI agent 160F.

AI model 162 of supervisor AI agent 160A may comprise a generative language model (e.g., small or large language model) or generative coding model that is fine-tuned or otherwise trained to generate database queries in one or more query languages (e.g., SQL, GraphQL, etc.).

In an embodiment, supervisor AI agent 160A may generate a prompt that comprises the query, received form query engine 105, and an instruction to divide or decompose the query into a separate and distinct subquery for each data source 115 that is referenced in the query. AI model 162 of supervisor AI agent 160A may then be applied to the prompt to generate the plurality of subqueries. At a high level, AI model 162 may be trained to recognize the referenced data sources 115 in the query, which data fields (e.g., columns) in the query belong to which data sources 115, and separate the respective data fields and data sources 115 into separate and distinct subqueries.

In an embodiment, supervisor AI agent 160A may generate a prompt that comprises the query, received from query engine 105 and/or the plurality of subqueries generated from the query, and an instruction to generate a query for performing an in-memory join of the results of the plurality of subqueries. AI model 162 of supervisor AI agent 160A may then be applied to the prompt to generate the query for performing the in-memory join. Supervisor AI agent 160 may execute the query, generated by AI model 162, to perform an in-memory join of the results of the plurality of subqueries into a final query result.

Query optimization AI agent 160B may dynamically rewrite a query, to push filtering operations to data sources 115, prior to data retrieval, and/or determine the optimal execution paths for distributed joins of data across two or more data sources 115. Supervisor AI agent 160A may send the plurality of subqueries to query optimization AI agent 160B to be processed, and query optimization AI agent 160B may return the rewritten query, comprising the plurality of subqueries, in which at least one subquery has been rewritten, to supervisor AI agent 160A.

AI model 162 of query optimization AI agent 160B may comprise a generative language model (e.g., small or large language model) or generative coding model that is fine-tuned or otherwise trained to generate database queries in one or more query languages (e.g., SQL, GraphQL, etc.). In an embodiment, query optimization AI agent 160B may generate a prompt that comprises one or more, including potentially all, of the plurality of subqueries, and an instruction to rewrite the subquery or subqueries according to one or more rules, constraints, preferences, or other optimization factors. The optimization factor(s) may comprise a constraint on the number of records to be fetched from the respective data source 115 at a time, a selection of a particular path for a data source 115, a selection of a particular path for a destination of the data, the removal of columns that are not needed for the query, and/or the like. AI model 162 of query optimization AI agent 160B may then be applied to the prompt to rewrite the subquery or subqueries according to the applicable optimization factor(s). In an embodiment, the rewriting of a subquery may comprise rewriting the subquery to perform filtering at a respective one of data sources 115 to which the at least one subquery is directed, prior to data retrieval from the respective data source 115.

Data location AI agent 160C may maintain or access metadata about the locations of federated data sources 115, determine an execution strategy for the plurality of subqueries, including an ordering of the subqueries, the optimal location(s) for the data to be retrieved by the plurality of subqueries, the prevention of redundant data movement, the prevention of unnecessary data retrieval (e.g., columns that are unnecessary for the query), and/or the like, based on the metadata and the query's structure. Supervisor AI agent 160A may send the plurality of subqueries, including any rewritten subqueries, to data location AI agent 160C, and data location AI agent 160C may return the optimal execution strategy to supervisor AI agent 160A.

AI model 162 of data location AI agent 160C may comprise a generative language model (e.g., small or large language model) that is fine-tuned or otherwise trained to determine an optimal execution strategy. In an embodiment, data location AI agent 160C may generate a prompt that comprises one or more, including potentially all, of the plurality of subqueries, and an instruction to determine the optimal execution strategy, according to one or more rules, constraints, preferences, or other optimization factors. AI model 162 of data location AI agent 160C may then be applied to the prompt to identify the optimal execution strategy for the plurality of subqueries. The execution strategy may comprise an order in which to execute the plurality of subqueries, including indications when two or more subqueries can be executed in parallel and/or when one subquery is dependent on another subquery such that it must be executed serially after that other subquery, the locations of data sources 115 to which the subqueries should be directed, the locations of data destination(s) to which retrieved data should be moved, and/or the like.

Execution AI agent 160D may delegate query execution to multiple federated engines (e.g., Presto, Snowflake, etc.), ensure parallel execution across multiple data sources 115 when possible, and/or dynamically balance query load. Supervisor AI agent 160A may send the plurality of subqueries, including any rewritten subqueries and including the optimal execution strategy, to execution AI agent 160D, which may initiate execution of each of the subqueries, according to the optimal execution strategy, and return the results of the subquery executions to supervisor AI agent 160A.

Cursor AI agent 160E may create virtual cursors for federated joins, to thereby retrieve data from data sources 115 incrementally instead of performing full table scans, and/or implement lazy loading to minimize unnecessary data movements. Supervisor AI agent 160A or execution AI agent 160D may utilize cursor AI agent 160E to maintain cursors for fetching the results of the plurality of subqueries.

A cursor is a mechanism used to incrementally retrieve and process federated data from data sources 115. A cursor acts a pointer or iterator over a result set, returned by one or more data sources 115, that enables retrieval of data chunks or batches, one at a time, of the overall result set, thereby avoiding the need to load the entire result set into memory at once. Cursor AI agent 160E may maintain a cursor to fetch a result of each of the plurality of subqueries, and return the fetched results, in batches. It should be understood that the cursor will be moved forward, after each fetch, in an increment equal to the amount of data that were fetched. Execution AI agent 160E or supervisor AI agent 160A may utilize cursor AI agent 160E to manage cursors, so that the results of the subquery executions may be returned to supervisor AI agent 160A in batches.

Lazy loading refers to a programming technique by which data are loaded only when accessed, rather than being initialized at the start of execution. Cursor AI agent 160E may implement lazy loading, so as to avoid retrieving data until and unless that data are actually needed.

Learning AI agent 160F may track performance metrics of queries (e.g., execution time, cost of data movements, etc.), utilize reinforcement learning to refine query execution strategies, and/or continuously update query routing decisions based on past query executions. For example, learning AI agent 160F may identify query executions with high performance metrics, and store the execution strategies for those high-performing query executions within historical data. The historical data may be used by or to train one or more of the other AI agents 160 in federation layer 110, such as data location AI agent 160C, to determine identical or similar execution strategies for subsequent queries that are identical or similar to those for which the execution strategy was previously determined.

Embodiments of federation layer 110 may handle ordered cursors for external joins. During a federated join across multiple data sources 115, a cursor (e.g., managed by cursor AI agent 160E) maintains the state of the query, which allows federation layer 110 to retrieve rows incrementally. This improves the performance and scalability of federation layer 110, and is crucial when computational resources (e.g., processing capacity, memory capacity, network bandwidth, etc.) are limited. Cursor-based joins require ordered data chunks for efficient batch-wise execution. The agentic framework of federation layer 110 may sort the fetched data chunks before joining to maintain consistency. If a plurality of tables are joined across a plurality of data sources 115, the agentic framework may dynamically optimize the order of query execution based on statistical analysis of past query executions.

Embodiments of federation layer 110 may minimize expensive data movements. Instead of treating all federated joins as inefficient, federation layer 110 may identify the most cost-effective strategies, in terms of data movement. In an embodiment, execution AI agent 160D temporarily moves smaller tables in joins next to larger tables in the joins, to optimize processing. In other words, during execution of the plurality of subqueries, by execution AI agent 160D, when a smaller table must be joined with a larger table, the smaller table may be temporarily copied to a location of the larger table, and the join may be performed at the location of the larger table and the copy of the smaller table. In addition, execution AI agent 160D may dynamically determine whether data movement or remote execution is more cost efficient based on current workload.

Embodiments of federation layer 110 may collect statistics and perform adaptive optimization based on the collected statistics. In particular, federation layer 110 may maintain performance statistics for query executions, to optimize future query routing decisions. Historical performance statistics may be utilized to inform intelligent query decomposition into subqueries and execution ordering of those subqueries.

In an embodiment, the agentic framework is designed with robust error handling capabilities to address various edge cases. For example, federation layer 110 may implement “circuit breakers” to prevent cascading failures when a data source 115 becomes unresponsive. If a data source 115 becomes unavailable during query execution, federation layer 110 can return partial results with appropriate explanations, rather than failing completely. For query timeout management, federation layer 110 may monitor execution time against configurable timeout thresholds, and implement graceful degradation strategies when the timeout thresholds are exceeded. Federation layer 110 may also handle scenarios in which a schema of a data source 115 evolves over time, by automatically refreshing metadata when the schema of a data source 115 changes. In addition, security constraints are respected throughout query execution, with the agentic framework implementing data source access controls and supporting row/column level security where applicable. For extremely large result sets, federation layer 110 may implement progressive result streaming to manage memory consumption and provide responsive feedback to the user or software entity that submitted the query.

### 4. Process

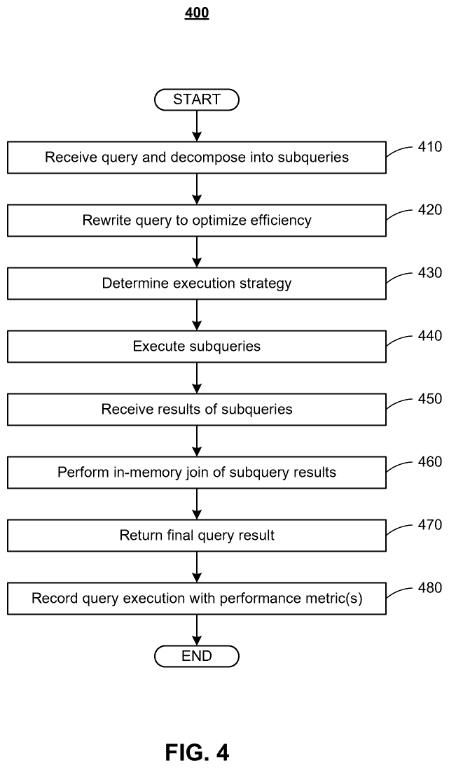

FIG. 4 illustrates an example process 400 for optimized query execution in federated data systems, according to an embodiment. Process 400 may be implemented by federation layer 110. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

A concrete example of a query will be described in parallel with the description of process 400. It should be understood that this is a simple example that is being provided merely to aid in the understanding of process 400, and should not be construed as limiting in any manner. In this concrete example, a user has submitted an SQL query with the goal of analyzing customer purchases, stored at a first data source 115 (i.e., a CRM database), and marketing campaign responses, stored at a second data source 115 (i.e., as Simple Storage Service (S3) objects within S3 storage provided by Amazon Web Services). The objective of federation layer 110, as embodied in process 400, is to minimize data movement and optimize execution of the query. Challenges and considerations, faced by federation layer 110, include, without limitation, that the CRM database stores structured customer records in a relational database (e.g., PostgreSQL), the marketing data comprise semi-structured click data (e.g., PrestoSQL), queries need an efficient join without unnecessary data movements, only relevant records should be retrieved instead of full table scans, and efficiency of the query execution should be ensured by optimizing pushdown filtering, execution order, and lazy loading.

Initially, subprocess 410, which may be implemented by supervisor AI agent 160A, may receive a query for a federated data system that comprises a plurality of distributed data sources 115. The query may be received, by supervisor AI agent 160A, from query engine 105. For example, a user may submit the query to query engine 105, via a user interface, or a software entity may submit the query to query engine 105, via an application programming interface of query engine 105. The query may be in a query language, such as SQL or GraphQL.

Using the concrete example from above, the query may be an SQL query to join customer data stored in the CRM database (crm) with marketing data stored in the S3 database (s3), i.e., across two different data sources 115:
SELECT crm.customer_id, crm.name, marketing.campaign_name, marketing.clicks
FROM crm_database.customers AS crm
JOIN s3.marketing_data AS marketing
ON crm.customer_id=marketing.customer_id
WHERE marketing.clicks>100;

Subprocess 410 may decompose the query into a plurality of subqueries. Firstly, supervisor AI agent 160A may recognize the intent of the query, which may comprise the identity of data sources 115 referenced in the query. Secondly, supervisor AI agent 160A may decompose the query into a subquery for each of the plurality of data sources 115 referenced in the query. It should be understood that the number of subqueries will generally correspond to the number of unique data sources 115 referenced in the query. In other words, subprocess 410 may identify each of the plurality of data sources 115 referenced in the query, and generate a subquery for each of the identified data sources 115. When generating a subquery, supervisor AI agent 160A may identify the data source 115 to which each data field, referenced in the query, belongs, and sort each data field into the subquery for the respective data source 115 to which the data field belongs.

Continuing the concrete example from above, subprocess 410 may determine that the query references two data sources 115, consisting of the CRM database, represented by a first data source 115, and an S3 database, comprising marketing data and represented by a second data source 115, and generate two separate and distinct subqueries:
SELECT customer_id, name FROM crm_database.customers;
SELECT customer_id, campaign_name, clicks FROM s3.marketing_data;
   Notably, one of the subqueries is directed solely to the CRM database, and the other subquery is directed solely to the marketing database. Subprocess 410 has determined which data fields (i.e., columns) belong to which database, and has sorted those data fields into the subquery for the database to which they belong.

Subprocess 420, which may be implemented by query optimization AI agent 160B, may rewrite at least one of the plurality of subqueries to minimize or reduce data movement and/or otherwise optimize efficiency to reduce the cost of query execution, in terms of data movement and/or other factors. In particular, query optimization AI agent 160B may perform dynamic query transformation to reduce the data movement and/or execution cost. A rewritten subquery may push filtering of the data to the respective data source 115, so that filtering is applied to the data before retrieval, instead of fetching full datasets, to thereby minimize data movement. In other words, filtering is done in the subquery at data source 115, rather than on the results that are returned by data source 115. In addition, a rewritten subquery may only retrieve the data (e.g., columns) that are required to be retrieved for the query, thereby minimizing the payload size of the query.
Continuing the concrete example from above, subprocess 420 may rewrite the query as: SELECT customer_id, name FROM crm_database.customers;
SELECT customer_id, campaign_name, clicks FROM s3.marketing_data WHERE clicks>100;

Notably, the second subquery to the S3 database has been rewritten to only retrieve marketing records WHERE clicks>100 to reduce the amount of data that are moved. This WHERE clause represents a filter that is pushed to the data source 115, since it is included within the subquery and excludes marketing data for which the number of clicks were less than or equal to 100 (e.g., representing trivial customer engagement) from needing to be retrieved, thereby reducing data movement.

Subprocess 430, which may be implemented by data location AI agent 160C, may determine an execution strategy that comprises the plurality of subqueries, as rewritten by query optimization AI agent 160B in subprocess 420. The execution strategy may specify an order in which the plurality of subqueries are to be executed. Two or more of the subqueries may be independent from each other, such that they may be executed in parallel. Alternatively or additionally, two or more of the subqueries may be dependent, such that one subquery needs to be executed before the other subquery. It should be understood that the execution strategy may include parallel execution of two or more subqueries and/or serial execution of two or more subqueries.

Data location AI agent 160C may identify the optimal execution strategy based on data location, existing metadata, and/or the like. For example, data location AI agent 160C may determine the location (e.g., network address) of the optimal data source 115 to be queried by each subquery, when to move data, the optimal locations to move data when deciding to move data, and/or the like. Data location AI agent 160C may also determine the particular query language to be used in the subquery for each data source 115. In particular, data location AI agent 160C may determine the query language associated with each data source 115, and ensure that each subquery utilizes the determined query language for the respective data source 115 from which that subquery is to retrieve data. In addition, data location AI agent 160C may ensure that the appropriate indices are used in each subquery, establish suitable partitions, and/or the like. Data location AI agent 160C may also determine whether or not the results for one or more subqueries, including potentially the entire query, are already stored within a cache. In this case, data location AI agent 160C may fetch the results from the cache instead of re-executing the subquery or subqueries on each data source 115. In other words, data location AI agent 160C may optimize the routing of each subquery.

Data location AI agent 160C may maintain or have access to a cache, and check the cache for data to be retrieved by one or more of the subqueries. If the data for a subquery are found within the cache, data location AI agent 160C may specify the path for the subquery as the cache, rather than the respective data source 115. It should be understood that when data are retrieved from data sources 115 by subqueries, that data may be temporarily stored in the cache for subsequent retrieval by subsequent subqueries. Standard caching techniques may be used to maintain and manage the cache.

Continuing the concrete example from above, subprocess 430 may determine the following execution strategy, including optimal routing to respective query engines, for the subqueries:
CRM Subquery→PostgreSQL Engine
Marketing Subquery→Presto Engine (S3 Storage)
   In this case, no data were found in the cache, so both subqueries are routed to the query engines of their respective data sources 115. The routing decision for the CRM query minimizes cross-system data movement, and the marketing query leverages built-in filtering capabilities.

Subprocess 440, which may be implemented by execution AI agent 160D, may execute the plurality of subqueries, determined in subprocess 410, as rewritten in subprocess 420, in the order and according to the routing specified by the execution strategy that was determined in subprocess 430. In a preferred embodiment, the plurality of subqueries are executed in parallel whenever possible (e.g., when one subquery is not dependent on the completion of another subquery), to maximize efficiency. It should be understood that, depending on dependencies, all subqueries may be executed in parallel, all subqueries may be executed serially, or a subset of subqueries may be executed in parallel while another subset of subqueries may be executed serially. Execution AI agent 160D may execute each subquery by routing each subquery to the the query engine of the respective data source 115, according to the optimal execution strategy determined in subprocess 430.

Execution AI agent 160D may make decisions regarding data movement versus local processing of data. For example, whenever it is more efficient for a subquery that joins a smaller table with a larger table, execution AI agent 160D may automatically make the decision to move the smaller table next to the larger table when executing that subquery, as opposed to moving the larger table next to the smaller table. By ensuring that the smaller table is the one that is moved, data movement can be minimized.

Continuing the concrete example from above, subprocess 440 may submit the CRM subquery to the query engine of a first data source 115, representing the CRM database. Similarly, subprocess 440 may submit the marketing subquery to the query engine of a second data source 115, representing the marketing database. The subqueries may be submitted in parallel, since the CRM and marketing queries are independent from each other. The respective data sources 115 may run their respective subqueries, in parallel, to produce respective results for each subquery.

Subprocess 450, which may be implemented by cursor AI agent 160E, may receive the result from each of the plurality of subqueries in the execution strategy. In particular, cursor AI agent 160E may fetch the result of each of the plurality of subqueries, and return the fetched results. Cursor AI agent 160E may fetch the records in one or more of the results in small increments, as data chunks or batches, to reduce memory overhead. It should be understood that, if the number of records in a result of a subquery is small (e.g., less than a threshold), all of the records in the result of the subquery may be fetched at once. On the other, if the number of records in a result of a subquery is large (e.g., greater than or equal to a threshold), the records in the result may be fetched in the small increments (e.g., in increments of the threshold or less). Lazy loading records in this manner efficiently utilizes memory by retrieving only the required records, and avoids loading large datasets into memory, thereby reducing query execution costs and the need for large memory allocations. During fetching of the query results, cursor AI agent 160E will ensure that the records are retrieved in an ordered manner, when required. Cursor AI agent 160E may return the results from the plurality of subqueries, as they are fetched, to supervisor AI agent 160A, assuming that supervisor AI agent 160A communicates directly with cursor AI agent 160E, or execution AI agent 160D in the event that execution AI agent 160D communicates directly with cursor AI agent 160E.

In an embodiment, cursor AI agent 160E may optimize the number of records that are fetched by cursor AI agent 160E in each data chunk or batch. In particular, the number of records per batch may be optimized based on one or more factors, such as the total amount of data that need to be fetched, the location of the data, the amount of computational resources (e.g., processing capacity, memory capacity, network capacity, etc.) available, limits applicable to a data source 115 (e.g., rate limits), a priority of the subquery or overall query, current traffic (e.g., in network(s) 120), and/or the like. The number of records may be dynamically optimized, such that the number of records retrieved by cursor AI agent 160E in each batch changes over time, as the values of the factor(s) change over time. In other words, the size of the batches may be limited to a maximum size, and cursor AI agent 160E may adjust the maximum size, over time, based on one or more real-time factors.

Continuing the concrete example from above, subprocess 450 may fetch the results for both subqueries in batches, with a maximum size of one-hundred records, as follows:
DECLARE customer_cursor CURSOR FOR
SELECT customer_id, name FROM crm_database.customers;
FETCH 100 FROM customer_cursor;
Declare Marketing_cursor Cursor for
SELECT customer_id, campaign_name, clicks FROM s3.marketing_data
WHERE clicks>100;
Fetch 100 From Marketing_cursor;

Subprocess 460, which may be implemented by supervisor AI agent 160A, may perform an in-memory join of the results from the plurality of subqueries, received in subprocess 450, to produce a final query result. It should be understood that, due to the fetching of results in increments in subprocess 450, the results may be returned to supervisor AI agent 160A in increments. Thus, supervisor AI agent 160A may perform a plurality of distributed in-memory joins, as the partial results are incrementally returned by cursor AI agent 160E, to produce the final query result. In other words, subprocess 460 may incrementally join batches of results as they are returned. This avoids the need to move full tables across data sources 115, in order to centralize full tables into one system. In addition, if the query crashes before completion (e.g., because a data source 115 timeouts, goes offline, or otherwise fails), supervisor AI agent 160A will still be able to return a partial query result comprising all of the data that have been acquired up to the time of the crash.

Continuing the concrete example from above, subprocess 460 may perform the following in-memory join:
SELECT crm.customer_id, crm.name, marketing.campaign_name,
marketing.clicks
FROM crm_cursor crm
JOIN marketing_cursor marketing
ON crm.customer_id=marketing.customer_id;

Subprocess 470, which may be implemented by supervisor AI agent 160A, may return the final query result, produced in subprocess 460, in response to the query that was received in subprocess 410. If the query was received from a user via a user interface, the final query result may be returned to the user via the user interface. Similarly, if the query was received from a software entity via an application programming interface, the final query result may be returned to the software entity via the application programming interface.

Subprocess 480, which may be implemented by learning AI agent 160F, may store the execution strategy, determined in subprocess 430, and executed in subprocess 440, in association with a representation of the query and metadata about the execution of the query. The representation of the query may comprise or consist of the query itself and/or one or more elements of the query. The metadata may comprise one or more performance metrics for the execution of the query. The performance metric(s) may comprise the execution time for the query, the amount of data moved between data sources 115, an indexing efficiency, a frequency of similar queries, and/or the like.

In an embodiment, execution strategies, for which the performance metric(s) satisfy one or more criteria representing high performance, may be stored in historical data in association with the respective queries for which those execution strategies were determined. The one or more criteria may comprise the value of a performance metric, or each of a combination of a plurality of performance metrics, satisfying a respective threshold (e.g., being greater than a threshold, being greater than or equal to a threshold, being less than a threshold, being less than or equal to a threshold, etc.). When a new query is received, for example, by supervisor AI agent 160A, the query may be compared to the queries in the historical data. When a matching query is found for the received query, the execution strategy for that query may be retrieved and reused for execution of the received query. In other words, past execution strategies, which demonstrate high performance, can be reused, thereby saving computational resources, since the execution strategy does not have to redetermined and an execution strategy with low performance can be averted. Essentially, learning AI agent 160F stores performance data to optimize future queries.

Learning AI agent 160F may determine whether or not indexing changes are needed. For example, if subqueries are frequently searching a data source 115, based on a data field for which no index has been built, learning AI agent 160F may determine that an index should be built for that data field. In this case, learning AI agent 160F may recommend a modification to the schema of data source 115 that includes the addition of an index, for the frequently searched data field, to the schema. This recommendation may be provided within a chat interface of learning AI agent 160F, sent as a notification to a user via a dashboard or other graphical user interface of the user account or via other standard messaging means (e.g., email address, text message, etc.), sent as a message to a software entity, and/or the like.

As described herein, federation layer 110 provides an AI-driven multi-agent framework that optimizes query execution across federated data sources 115 by reducing data movement, optimizing execution paths, and learning from historical query performance. Unlike traditional federation layers, which execute queries with static strategies and full-table retrievals, disclosed embodiments of federation layer 110 leverage intent-aware optimization, cursor-based retrieval, and self-learning execution. This multi-agent framework dynamically distributes query processing among specialized AI agents 160, which are each responsible for respective tasks, such as query decomposition, optimization, distributed execution, and learning-based refinement. By minimizing network congestion, optimizing federated joins, and leveraging reinforcement learning for query improvement, federation layer 110 significantly enhances performance, cost efficiency, and adaptability, in complex federated data environments. Federation layer 110 is particularly valuable for federated queries across relational databases, NoSQL stores, object storage, and streaming data sources 115, making it ideal for enterprise-scale data analytics and real-time data processing.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, in a federation layer of a federated data system that comprises a plurality of distributed data sources:
by a supervisor artificial intelligence (AI) agent, receive a query for the federated data system, and decompose the query into a plurality of subqueries;
by a query optimization AI agent, rewrite at least one of the plurality of subqueries to minimize data movement;
by a data location AI agent, determine an execution strategy that comprises the plurality of subqueries, as rewritten by the query optimization AI agent;
by an execution AI agent, execute the plurality of subqueries;
by a cursor AI agent, fetch a result of each of the plurality of subqueries, and return the fetched results; and
by the supervisor AI agent, perform an in-memory join of the fetched results, to produce a final query result, and return the final query result in response to the received query.

2. The method of claim 1, wherein decomposing the query into a plurality of subqueries comprises:
identifying each of the plurality of distributed data sources referenced in the query; and
for each of the identified distributed data sources, generating a subquery.

3. The method of claim 1, wherein decomposing the query into the plurality of subqueries comprises:
generating a prompt that comprises the query and instructs an AI model of the supervisor AI agent to decompose the query into a separate and distinct subquery for each of the plurality of distributed data sources that is referenced in the query;
apply the AI model of the supervisor AI agent to the prompt to generate the plurality of subqueries.

4. The method of claim 3, wherein the AI model is a large language model that is fine-tuned for generating queries.

5. The method of claim 1, wherein rewriting the at least one subquery comprises rewriting the at least one subquery to perform filtering at a respective one of the plurality of distributed data sources to which the at least one subquery is directed, prior to data retrieval from the respective distributed data source.

6. The method of claim 1, wherein, during execution of the plurality of subqueries, when a smaller table must be joined with a larger table, the smaller table is temporarily copied to a location of the larger table, and the join is performed at the location of the larger table and the copy of the smaller table.

7. The method of claim 1, wherein the cursor AI agent maintains a cursor to fetch the result of each of the plurality of subqueries and return the fetched results in batches.

8. The method of claim 7, wherein a size of the batches is limited to a maximum size, and wherein the maximum size is adjusted, over time, based on one or more real-time factors.

9. The method of claim 1, wherein two or more of the plurality of subqueries are executed in parallel.

10. The method of claim 1, further comprising using the at least one hardware processor to, by a learning AI agent, store the execution strategy in association with a representation of the query and metadata about execution of the query.

11. The method of claim 10, wherein the metadata comprise one or more performance metrics for the execution of the query.

12. The method of claim 11, further comprising using the at least one hardware processor to, by the learning AI agent, when the one or more performance metrics satisfy one or more criteria, store the execution strategy in historical data used to optimize future queries.

13. The method of claim 11, further comprising using the at least one hardware processor to, by the learning AI agent, recommend a modification to a schema of at least one of the plurality of distributed data sources based on the one or more performance metrics, wherein the modification comprises an addition of an index to the schema.

14. The method of claim 1, wherein the query is received from a query engine of the federated data system, and wherein the final query result is returned to the query engine.

15. The method of claim 14, wherein the query is received by the query engine from a user via a user interface.

16. The method of claim 14, wherein the query is received by the query engine from a software entity via an application programming interface of the query engine.

17. The method of claim 16, wherein the software entity is an integration process.

18. The method of claim 1, wherein the federation layer is hosted on an integration platform as a service (iPaaS) platform.

19. A system comprising:
at least one hardware processor; and
a federation layer, comprising a plurality of artificial intelligence (AI) agents, of a federated data system, comprising a plurality of distributed data sources, that is configured to, when executed by the at least one hardware processor,
by a supervisor AI agent, receive a query for the federated data system, and decompose the query into a plurality of subqueries,
by a query optimization AI agent, rewrite at least one of the plurality of subqueries to minimize data movement,
by a data location AI agent, determine an execution strategy that comprises the plurality of subqueries, as rewritten by the query optimization AI agent,
by an execution AI agent, execute the plurality of subqueries,
by a cursor AI agent, fetch a result of each of the plurality of subqueries, and return the fetched results, and
by the supervisor AI agent, perform an in-memory join of the fetched results, to produce a final query result, and return the final query result in response to the received query.

20. A non-transitory computer-readable medium having instructions stored therein, wherein the instructions, when executed by a processor, cause the processor to, in a federation layer of a federated data system that comprises a plurality of distributed data sources:
by a supervisor artificial intelligence (AI) agent, receive a query for the federated data system, and decompose the query into a plurality of subqueries;
by a query optimization AI agent, rewrite at least one of the plurality of subqueries to minimize data movement;
by a data location AI agent, determine an execution strategy that comprises the plurality of subqueries, as rewritten by the query optimization AI agent;
by an execution AI agent, execute the plurality of subqueries;
by a cursor AI agent, fetch a result of each of the plurality of subqueries, and return the fetched results; and
by the supervisor AI agent, perform an in-memory join of the fetched results, to produce a final query result, and return the final query result in response to the received query.
